(19) United States
(12) Patent Application Publication
(10) Pub. No.: US 2006/0050520 A1
(43) Pub. Date: Mar. 9, 2006

(54) Illuminating or signaling light in the form of a strip comprising a stepped planar mirror

(76) Inventor: Patrice Collot, Bobigny (FR)

Correspondence Address: MORGAN & FINNEGAN, L.L.P., 3 WORLD FINANCIAL CENTER, NEW YORK, NY, 10281-2101, US

(21) Appl. No.: 11/206,395

(22) Filed: Aug. 17, 2005

(30) Foreign Application Priority Data
Sep. 7, 2004 (FR) 04 09 478

(51) Int. Cl. B60Q 1/076

(52) U.S. Cl. 362/459

(57) ABSTRACT

The invention concerns an illuminating or signaling light for a motor vehicle that is designed to produce a regulatory lighting or signaling beam directed roughly towards the front along a longitudinal optical axis, comprising a light source, first second reflectors that are arranged laterally on each side of the light source, and that reflect the light rays emitted by the source roughly longitudinally towards the front, on the rear face of a distribution screen that is arranged longitudinally facing the reflectors so as to at least laterally spread the light rays with a view to forming the regulatory beam, of the type in which the distribution screen has roughly the shape of a strip stretched in the direction of its length, at least one reflector being formed by a stepped plane, the stepped plane comprising a series of substantially parallel reflection facets, a first optical element being interposed on the path of the light rays emitted by the light source, between the light source and the stepped plane, the first optical element being designed to straighten up the light rays emitted by the source in a substantially parallel light beam directed towards the stepped plane, which by reflection returns the light rays in a longitudinal direction oriented towards the front. According to the invention, the first optical element is a Fresnel element, the first reflector is a stepped plane and the second reflector is a roughly parabolic mirror, the light source being arranged substantially at the focus of the parabola.

### FIELD OF THE INVENTION

The present invention concerns an illuminating or signaling light for a motor vehicle that is designed to produce a regulatory lighting or signaling beam directed roughly towards the front along a longitudinal optical axis, comprising a light source, first and second reflectors that are arranged laterally, with respect to the longitudinal direction, on each side of the light source, and that reflect the light rays emitted by the source roughly longitudinally towards the front, on the rear face of a distribution screen that is arranged longitudinally facing the reflectors so as to at least laterally spread the light rays with a view to forming the regulatory beam, of the type in which the distribution screen has roughly the shape of a strip stretched in the direction of its length, at least one reflector being formed by a stepped plane, the stepped plane comprising a series of substantially parallel reflection facets, a first optical element (38) being interposed on the path of the light rays emitted by the light source (16), between the light source (16) and the stepped plane (20), the first optical element (38) being designed to straighten up the light rays emitted by the source (16) in a substantially parallel light beam directed towards the stepped plane (20), which by reflection returns the light rays in a longitudinal direction oriented towards the front.

### BACKGROUND OF THE INVENTION

Such a light is known for example from the document EP-A-0 299 091.

It is already known how to produce signaling lights in the form of a light strip stretched for example horizontally.

Local manufacturers manifest a particular interest in this type of light since they are integrated aesthetically and aerodynamically in the vehicle lines.

However, when a light is produced that is stretched over a great length, it is not possible to use solely reflectors with a roughly parabolic shape to illuminate the distribution screen substantially homogenously over its entire surface. This is because the space available on the vehicle does not generally permit the use of a sufficiently deep parabola for collecting the flux necessary for fulfilling the function.

If a parabola with a large focal length is used, the flux collected is then too small to make it possible to produce effective regulatory beams.

To remedy this problem, it is possible to use stepped parabolas, but this solution does not resolve the problem of the light flux, which is still too small at the lateral ends of the light, that is to say at the ends of the strip.

There is therefore obtained a light comprising an illuminating range lacking homogeneity, the light intensity being strong at the middle of the light and weak at the edges, compared with the strong intensity of the centre.

Document EP-B-0.290.347 describes and depicts an example of a so-called linear light design having an almost homogeneous illuminating range.

However, this design of light does not make it possible to obtain a sufficiently high light flux for fulfilling certain regulatory functions, in particular in the case of lights arranged in the front face of the vehicle.

In addition, this design of light involves very specialized techniques for producing the parts making up the light, in particular an output screen having on its internal face teeth working in total reflection.

The present invention aims to remedy these drawbacks by proposing a light having improved light yield.

### SUMMARY OF THE INVENTION

To this end, the invention proposes a lighting or signaling light of the type described above, in which the first optical element is a Fresnel element, and the first reflector is a stepped plane and the second reflector is a roughly parabolic mirror, the light source being arranged substantially at the focus of the parabola.

According to other characteristics of the invention:

the stepped plane is inclined with respect to a plane transverse to the optical axis starting from the rear of the light source at the edge of the output screen so as to illuminate the latter as far as the edge;

a second Fresnel optical element is interposed between the light source and the rear face of the distribution screen so as to straighten up longitudinally the light rays that are emitted by the light source directly towards the screen and which are not able to reach the reflectors;

one or more of the faces of the distribution screen comprise optical elements that distribute the light in order to form the regulatory beam;

the distribution screen is produced by a generatrix that can take various curved and/or inclined forms contained outside a horizontal plane;

the portion situated furthest to the rear corresponds to the portion of the light comprising the stepped plane;

the form of the reflectors and the orientation of the lenses are adapted to the form of generatrix of the distribution screen so that each reflector is always arranged longitudinally opposite the corresponding portion of the distribution screen;

the screen is integrated in the closure glass.

Other characteristics and advantages of the invention will emerge from a reading of the following detailed description, for an understanding of which reference will be made to the accompanying drawings, in which:

### BRIEF DESCRIPTION OF THE DRAWINGS

FIG. 1 is a partial perspective view that depicts a vehicle equipped with two signaling lights produced in accordance with the teachings of the invention;

FIG. 2 is a view in longitudinal section along a horizontal plane that depicts schematically the right-hand signaling light of the vehicle in FIG. 1.

For the description of the invention, the orientations vertical, longitudinal and transverse will be adopted non-limitingly according to the reference frame V, L, T indicated in the figures.

In the following description, identical, similar or analogous elements will be designated by the same reference numbers.

### DESCRIPTION OF THE PREFERRED EMBODIMENTS

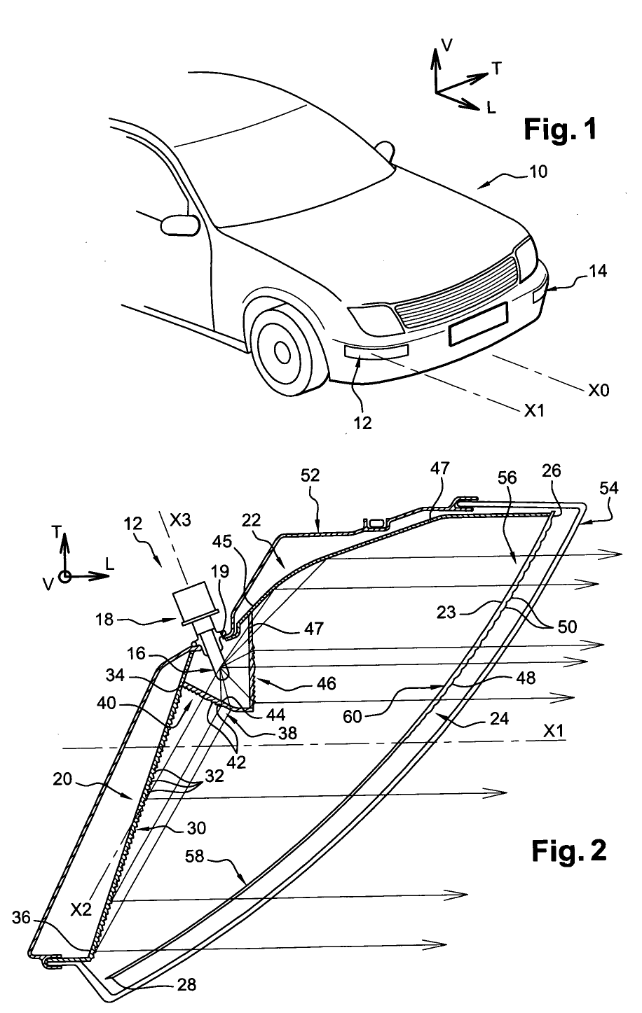

FIG. 1 depicts schematically the front face of a motor vehicle 10 that is equipped with two signaling lights, respectively right 12 and left 14 produced in accordance with the teachings of the invention.

Each of these lights 12, 14 fulfils for example a direction indicator function and therefore produces a corresponding regulatory lighting beam along a longitudinal optical axis X1 oriented towards the front and substantially parallel to the longitudinal axis X0 of the vehicle 10.

FIG. 2 depicts in detail the right-hand signaling light 12.

The orientation of the optical axis X1 from rear to front corresponds to an orientation from left to right when looking at FIG. 2, the left-side of the light 12 being situated at the top of FIG. 2 and the right-hand side being situated at the bottom of FIG. 2.

The light 12 comprises a light source 16 that consists here of the filament of a lamp 18.

According to the embodiment depicted here, the lamp 18 is inserted axially in a complementary housing 19 in an axial direction X3 that is contained in a horizontal plane inclined with respect to a transverse direction.

The light 12 comprises first 20 and second 22 reflectors that are arranged laterally, with respect to the optical axis X1, on each side of the light source 12, respectively to the right and left of the latter 16.

The reflectors 20, 22 reflect the light rays emitted by the source 16 roughly longitudinally towards the front, onto the rear face 23 of a distribution screen 24 that is arranged longitudinally facing the reflectors 20, 22.

The distribution screen 24 has roughly the shape of a strip that extends in the direction of its length, roughly along a generatrix in the form an arc of a circle contained in a horizontal plane.

The width of the distribution screen 24 is therefore less than its length.

The distribution screen 24 comprises a left-hand lateral end 26 that is arranged on the side of the longitudinal axis X0 of the vehicle 10, in front of the light 12, and a right-hand lateral end that is arranged on the same side as the right-hand flank of the vehicle 10, longitudinally to the rear with respect to the left-hand end 26.

The distribution screen 24 roughly matches the rounded shape of the bodywork portion of the vehicle 10 in which it is arranged. Consequently the arc of a circle described by the distribution screen 24 tends to approximate, towards the rear, to a longitudinal direction.

In accordance with the teachings of the invention, the first reflector 20 consists of a stepped plane.

The stepped plane 20 extends here in a substantially vertical plane that is inclined with respect to a transverse plane, the left-hand lateral end 34 of the stepped plane 20 being offset longitudinally towards the front relative to the right-hand lateral end 36.

The front face 30 of the stepped plane 20 comprises a series of vertical reflective facets 32 oriented roughly towards the front.

Advantageously the stepped plane 20 is inclined with respect to a plane transverse to the optical axis starting from the rear of the light source 16 in order to constitute the left-hand lateral end 34 as far as the right-hand lateral end 36 at the rear of the edge of the output screen 28.

According to another characteristic of the invention, a first Fresnel optical element, referred to as the first lens 38, is interposed on the path of the light rays emitted by the source 16, between the source 16 and the front face 30 of the stepped plane 20.

The first lens 38 extends here in a substantially vertical plane that describes roughly an acute angle with the front face 30 of the stepped plane 20.

The refraction lens elements 42, which are arranged on the optical output face 40 of the first lens 38, form here concentric rings or sectors of a ring, centred on a secondary optical axis X2 passing through the light source 16 and passing through the front face 30 of the stepped plane 20.

The secondary optical axis X2 thus forms a general incident direction that is directed towards the front face 30 of the stepped plane 20.

The light rays collected by the optical entry face 44 of the first lens 38 straighten up along the secondary optical axis X2 so as to allow the reflection of these light rays onto the facets 32 in longitudinal directions oriented towards the front.

Advantageously, the second reflector 22 is formed by a roughly parabolic mirror, the source 16 being arranged substantially at the focus of the parabola.

The parabolic mirror 22 extends, in its useful reflection surface, from the right-hand lateral end 46, on the source 16 side, to its left-hand lateral end 47 behind the end 26 of the output screen in the direction of the optical axis.

A second Fresnel optical element, referred to as the second lens 46, is interposed between the source 16 and the rear face 23 of the distribution screen 24 so as to longitudinally straighten up the light rays that are emitted by the source 16 directly towards the screen 24, without being reflected by the reflectors 20, 22.

The second lens 46 is produced in a similar manner to the first lens 38. It extends here in a transverse plane substantially perpendicular to the optical axis X1.

The second lens 46 is here offset longitudinally towards the front with respect to the front end edge of the first lens 38.

The second lens 46 extends laterally towards the longitudinal axis X0 of the vehicle through a transparent portion 47 that allows the light rays emitted by the source 16 to pass without diverting them, so that they reach the parabolic mirror 22 and so that they are reflected longitudinally towards the front.

The front face 48 of the distribution screen 24 preferably comprises optical diffusion elements 50 that laterally distribute the light rays received on its rear face 23 so that the light-distribution characteristics of the signaling beam are in accordance with the regulations.

These optical diffusion elements 50 are for example formed by a series of tori in the form of pads whose profile is optimized in order to distribute the light rays in the regulatory beam.

The optical diffusion elements 50 preferably have profiles which are very marked on the side of the left-hand lateral end 26 and which soften towards the rear lateral end 28. This makes it possible to take account of the greater inclination of the screen 24 with respect to the optical axis X1, on the right-hand lateral end side 28.

According to the embodiment depicted here, the various elements making up the light 12 are contained in a housing 52 which is closed at the front by a non-diverting protective glass 54 with a profile similar to the distribution screen 24.

The protective glass 54 is transparent or comprises optical elements which must be taken into account for calculating the optical distribution elements of the screen 24.

The screen 24 and protective glass 54 can be combined in a single component, which reduces the cost of the device.

It will be noted that the screen 24 has a first lateral portion, or left-hand portion 56, which receives the light rays reflected by the parabolic mirror 22, a second lateral portion or right-hand portion 58, which receives the light rays reflected by the stepped plane 20, and an intermediate portion 60, arranged between the two lateral portions 56, 58, which receives the light rays straightened up by the second lens 46.

It will be noted that the arrangement of the stepped plane 20 at the rear of the source 16 produces a signaling light having a straight portion 58 highly curved towards the rear and to the right.

According to the embodiment depicted here, the generatrix of the distribution screen 24 extends roughly in a horizontal plane.

According to varied embodiments (not shown) of the invention, the generatrix of the distribution screen 24 can take various curved and/or inclined forms that are not contained in a horizontal plane. In this case, the portion situated furthest to the rear always corresponds to the portion of the light 12 comprising the stepped plane 20.

Naturally the form of the reflectors 20, 22 and the orientation of the lenses 38, 46 are adapted to the form of the generatrix of the distribution screen 24 so that each reflector 20, 22 is always arranged longitudinally facing the corresponding portion 56, 58, 60 of the distribution screen 24.

For example, the right-hand lateral portion 58 can be both curved towards the rear and upwards from the intermediate portion 60. The edges of the stepped plane 20 connecting its two lateral ends 34, 36 follow the curve described by the right-hand lateral portion 58 of the screen 24 in a transverse vertical plane.

According to another example embodiment, the generatrix of the distribution screen 24 can be contained roughly in a longitudinal vertical plane.

The signaling light 12 according to the invention benefits from a particularly good light yield, whilst having good light homogeneity over the entire front face 48 of the distribution screen 24.

Naturally the left-hand signaling light 14 of the vehicle 10 is produced symmetrically with the right-hand signaling light 12, with respect to a vertical longitudinal plane of symmetry.

According to a variant embodiment (not shown), the light according to the invention produces a regulatory lighting beam without cut-off such as a main beam.

What is claimed is:

1. Illuminating or signaling light for a motor vehicle that is designed to produce a regulatory lighting or signaling beam directed roughly towards the front along a longitudinal optical axis, comprising a light source, first and second reflectors that are arranged laterally, with respect to the longitudinal direction, on each side of the light source, and that reflect the light rays emitted by the source roughly longitudinally towards the front, on the rear face of a distribution screen that is arranged longitudinally facing the reflectors so as to at least laterally spread the light rays with a view to forming the regulatory beam, of the type in which the distribution screen has roughly the shape of a strip stretched in the direction of its length, at least one reflector being formed by a stepped plane, the stepped plane comprising a series of substantially parallel reflection facets, a first optical element being interposed on the path of the light rays emitted by the light source, between the light source and the stepped plane, the first optical element being designed to straighten up the light rays emitted by the source in a substantially parallel light beam directed towards the stepped plane, which by reflection returns the light rays in a longitudinal direction oriented towards the front, wherein the first optical element is a Fresnel element, and in that the first reflector is a stepped plane and the second reflector is a roughly parabolic mirror, the light source being arranged substantially at the focus of the parabola.

2. Light according to claim 1, wherein the stepped plane is inclined with respect to a plane transverse to the optical axis starting from the rear of the light source at the edge of the output screen so as to illuminate the latter as far as the edge.

3. Light according to claim 1, wherein a second Fresnel optical element is interposed between the light source and the rear face of the distribution screen so as to straighten up longitudinally the light rays that are emitted by the light source directly towards the screen and which are not able to reach the reflectors.

4. Light according to claim 1, wherein one or more of the faces of the distribution screen comprise optical elements that distribute the light in order to form the regulatory beam.

5. Light according to claim 1, wherein the distribution screen is produced by a generatrix that can take various curved and/or inclined forms contained outside a horizontal plane.

6. Light according to claim 5, wherein the portion situated furthest to the rear corresponds to the portion of the light comprising the stepped plane.

7. Light according to claim 6, wherein the form of the reflectors and the orientation of the lenses are adapted to the form of generatrix of the distribution screen so that each reflector is always arranged longitudinally opposite the corresponding portion of the distribution screen.

8. Light according to claim 1, wherein the screen is integrated in the closure glass.
